(19) United States
(12) Patent Application Publication
(10) Pub. No.: US 2020/0173811 A1
(43) Pub. Date: Jun. 4, 2020

(54) SENSING OF A ROTATIONAL ANGLE

(71) Applicant: Infineon Technologies AG, Neubiberg (DE)

(72) Inventors: Wolfgang GRANIG, Seeboden (AT); Udo AUSSERLECHNER, Villach (AT)

(21) Appl. No.: 16/688,727

(22) Filed: Nov. 19, 2019

(30) Foreign Application Priority Data
Dec. 3, 2018 (DE) 102018130723.3

(51) Int. Cl. G01D 5/14; G01D 5/16

(52) U.S. Cl. CPC G01D 5/145; G01D 5/16

(57) ABSTRACT

A rotation angle sensing device is suggested, which comprises: a shaft that is rotatable around a rotation axis; a magnetic field source that is attached to the shaft; and at least one angle sensor that is arranged at an out-of-shaft location adjacent to the magnetic field source, wherein the angle sensor comprises a plane for measuring two components of a magnetic field emitted by the magnetic field source, and wherein the plane is tilted against an axis, which axis is the rotation axis of the shaft. Also, a corresponding method for sensing a rotational angle of a shaft is provided.

### CROSS REFERENCE TO RELATED APPLICATION

This application claims priority under 35 U.S.C. § 119 to German Patent Application No. 102018130723.3 filed on Dec. 3, 2018, the contents of which are incorporated by reference herein in their entirety.

### BACKGROUND

In many applications it is not an option to directly access the end of a shaft for angle measurement purposes. As a solution, a magnetic 3D sensor can be used by measuring the X-Y (X-Z or Y-Z) components. The sensor is located out of the shaft, e.g. not on the rotation axis of the shaft. The shaft itself has a magnetic encoder with at least two poles (one referred as N, the other as S).

Out-of-shaft angle sensing is getting increasingly popular because an angle position of a shaft is required in multiple applications, e.g., in the automotive, industry or consumer area. Angle sensing uses magnetic principles to ensure a high degree of robustness.

### SUMMARY

FIG. 1A shows an example setup to illustrate out-of-shaft angle sensing in the x-z-plane and FIG. 1B shows the x-y-plane of this very same setup.

A ring magnet 101 is arranged around a (rotatable) shaft 102. The shaft 102 rotates around a rotation axis 103. An angle sensor 104 is located out-of-shaft, e.g. not on the rotation axis 103 of the shaft 102.

The angle sensor 104 measures the x and y components of the magnetic field emitted by the ring magnet 101.

FIG. 2 visualizes magnetic flux densities 201 in view of rotational angles 202 based on the example shown in FIG. 1A and FIG. 1B. In FIG. 2,
a curve 203 shows a magnetic field component Bx in x-direction,
a curve 204 shows a magnetic field component By in y-direction, and
a curve 205 shows a magnetic field component Bz in z-direction.

The amplitude of the magnetic flux density (e.g. the magnetic) fields in x- and y-direction differ substantially from each other. This, however, may be detrimental for a magnetic angle sensor, because the x-component of the magnetic field is too high with regard to the magnetic field in y-direction.

It is desirable to improve existing solutions utilizing out-of-shaft angle sensing.

This is solved according to the features of the independent claims. Further implementations result from the depending claims.

The examples suggested herein may in particular be based on at least one of the following solutions. Combinations of the following features may be utilized to reach a desired result. The features of the method could be combined with any feature(s) of the device, apparatus or system or vice versa.

A rotation angle sensing device is provided comprising:
a shaft that is rotatable around a rotation axis;
a magnetic field source that is attached to the shaft;
at least one angle sensor that is arranged at an out-of-shaft location adjacent to the magnetic field source,
   wherein the angle sensor comprises a plane for measuring two components of a magnetic field emitted by the magnetic field source,
   wherein the plane is tilted against an axis, which axis is the rotation axis of the shaft.

The angle sensor may be or comprise a magnetic field sensor.

It is noted that the plane is tilted at an angle that is larger than 15° and smaller than 75°, such as in a range from approximately 15° to approximately 75°. Hence, in a Cartesian coordinate system, the plane may span the x-y-plane and the rotation axis may be the z axis. By tilting the x-y-plane, magnetic field components Bx and By can be adjusted such that their maximum amplitudes become similar, which allows for an efficient measurement of the rotation angle in particular when using MR sensors.

The two components of the magnetic field are different. As an option, the angle sensor comprises a plane for measuring two orthogonal components of the magnetic field emitted by the magnetic field source. The plane is preferably not orthogonal to the rotation axis but tilted against the rotation axis of the shaft. This allows that the amplitudes of the two components of the magnetic field converge.

The plane of a chip that acts as angle sensor is thus not orthogonal to the rotation axis of the shaft, but instead tilted against this rotation axis. The angle sensor may in particular be located on a circle around the rotation axis, wherein the circle is orthogonal to the rotation axis. Hence, at this circle there is a radial direction component, against which the plane of the chip is tilted. Hence, the magnetic field component in tangential direction remains (substantially) the same, whereas the magnetic field component in radial direction is reduced.

It is noted that based on the signals obtained by the at least one angle sensor, the rotation angle of the shaft can be determined by using an arctan function on the detected Bx field and the detected By field.

According to an implementation, the magnetic field source is fixed on the shaft and the magnetic field source comprises at least one of the following:
a permanent magnet;
a ring magnet.

It is noted that the magnetic field source may be arranged in a circular way around the shaft. It is an option that the magnetic field source comprises several magnets that are deployed on a substrate or any support medium.

The magnetic field source may be a dipole or a multipole.

It is an option that the magnetic field component in the direction of the rotation axis of the shaft is significantly (e.g., 10 times) smaller than the magnetic field component in diametral direction (orthogonal to the rotation axis). In an example, the magnetic field is periodic along the azimuth with a period amounting to 360°/N (N=1, 2, 3, . . . , n). An example maximum value for n may be 15.

It is an option that the permanent magnetic material of the magnetic field source is rotationally symmetric.

According to an implementation, the plane is tilted such that the two magnetic field components have the same amplitude or substantially the same amplitude.

According to an implementation, the angle sensor is part of a package, which is mounted on a printed circuit board.

According to an implementation, the package is tilted and/or the angle sensor within the package is tilted.

According to an implementation, the angle sensor is tilted by a tilt angle in the range between 15° and 75°.

According to an implementation, the at least one angle sensor comprises two angle sensors that are tilted in opposite directions.

According to an implementation, the at least one angle sensor is deployed at a location where the magnetic field component in a direction of the rotation axis is substantially zero.

According to an implementation, the angle sensor is placed adjacent to the magnetic field source, wherein a radial distance between the magnetic field source and the angle sensor amounts to 0.5 mm to 10 mm, such as a radial distance in a range from approximately 0.5 mm to approximately 10 mm.

According to an implementation, the angle sensor comprises at least one MR sensor, in particular at least one of the following sensors:
an AMR sensor;
a GMR sensor;
a TMR sensor.

According to an implementation, the angle sensor comprises at least one of the following:
a Hall plate;
a vertical Hall effect device.

Also, a method is suggested for sensing a rotational angle of a shaft that is arranged rotatable around a rotation axis, wherein a magnetic field source is attached to the shaft and wherein at least one angle sensor is arranged at an out-of-shaft location adjacent to the magnetic field source, wherein the angle sensor comprises a plane for measuring two components of a magnetic field emitted by the magnetic field source, wherein the plane is tilted against an axis, which axis is the rotation axis of the shaft, the method comprising:
determining the two magnetic field components in the plane of the angle sensor,
determining the rotational angle based on the two magnetic field components.

### BRIEF DESCRIPTION OF THE DRAWINGS

Implementations are shown and illustrated with reference to the drawings. The drawings serve to illustrate the basic principles, so that aspects for understanding the basic principles are illustrated. The drawings are not to scale. In the drawings, the same reference characters denote like features.

FIG. 1A shows an example setup to illustrate out-of-shaft angle sensing in an x-z-plane;

FIG. 1B shows the x-y-plane of the setup depicted in FIG. 1A;

FIG. 2 shows a diagram visualizing a magnetic flux density in view of a rotational angle;

FIG. 3 shows an example arrangement comprising a ring magnet that is connected to a (rotatable) shaft, wherein a tilted out-of-shaft angle sensor detects magnetic field components from the ring magnet;

FIG. 4 shows a diagram that visualizes the resulting magnetic field components based on the example arrangement of FIG. 3;

FIG. 5 shows an example arrangement, wherein an angle sensor is mounted on a printed circuit board (PCB) and wherein the package comprising the angle sensor is bent;

FIG. 6A shows another example arrangement, wherein an angle sensor is part of a package that is mounted on a PCB, wherein the package comprises the tilted angle sensor;

FIG. 6B shows the package of FIG. 6A in more detail;

FIG. 7A shows yet another example arrangement, wherein a stacked PCB arrangement supports an angle sensor that is arranged in the x-y-plane;

FIG. 7B shows the arrangement of FIG. 7A, wherein the angle sensor is arranged in the x-z-plane; and

FIG. 8 shows an example arrangement of two tilted angle sensors.

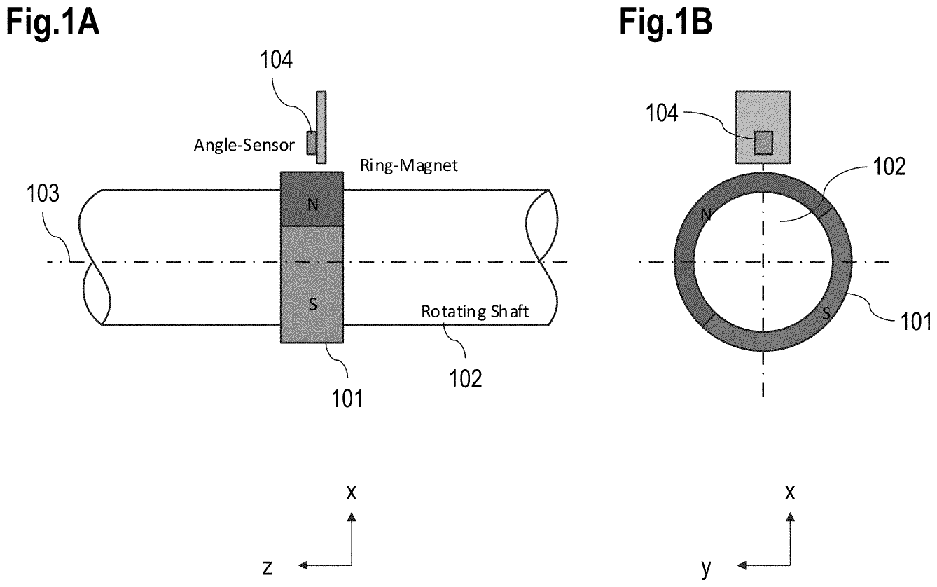

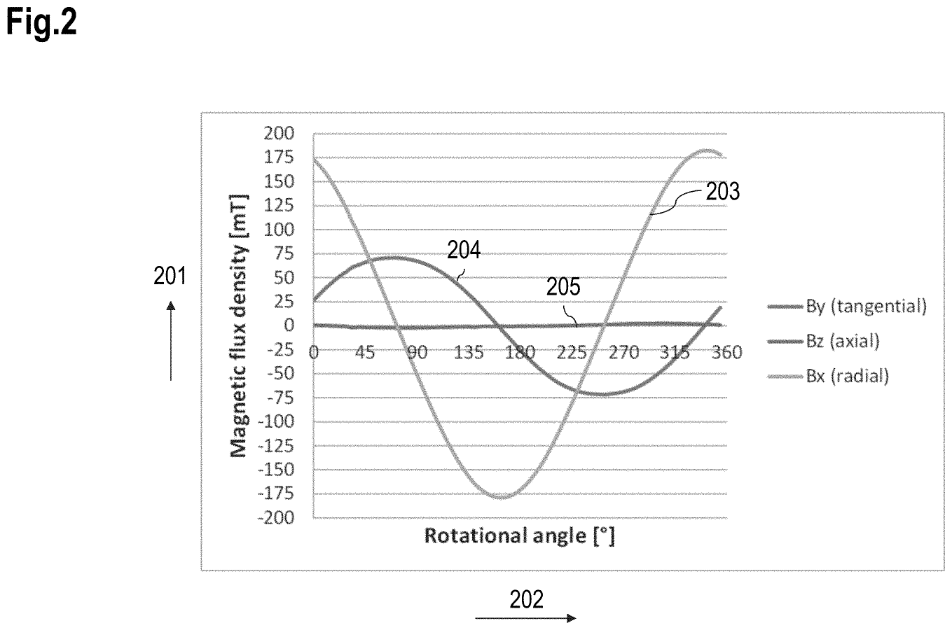

### DETAILED DESCRIPTION

Examples shown herein in particular suggest balancing the amplitudes of the magnetic field components in x- and y-directions by tilting an out-of-shaft angle sensor. It is noted that in this example terminology, the magnetic field components in x- and y-directions are to be measured by the angle sensor.

The angle sensor used herewith may be a magneto-resistive (MR) sensor. Such MR sensor may comprise at least one of the following: an AMR (Anisotropic MR) sensor, a GMR (Giant MR) sensor, a TMR (Tunneling MR) sensor. The approach presented could be used in combination with MR sensors, Hall plates or vertical Hall effect devices.

The angle sensor may comprise at least one sensor element. The sensor element may be or comprise at least one of the following: an AMR (Anisotropic MR) sensor, a GMR (Giant MR) sensor, a TMR (Tunneling MR) sensor, a Hall plate or a vertical Hall effect device.

The angle sensor may be a sensor package, a sensor component board or a sensor module.

The coordinates used herein are examples for illustration purposes. Other coordinates or different coordinate systems may be used accordingly.

In the example coordinate system, the angle sensor is tilted against the x-axis such that
the x-component of the magnetic field is decreased with respect to the y-component and
the y-component of the magnetic field is increased with respect to the x-component.

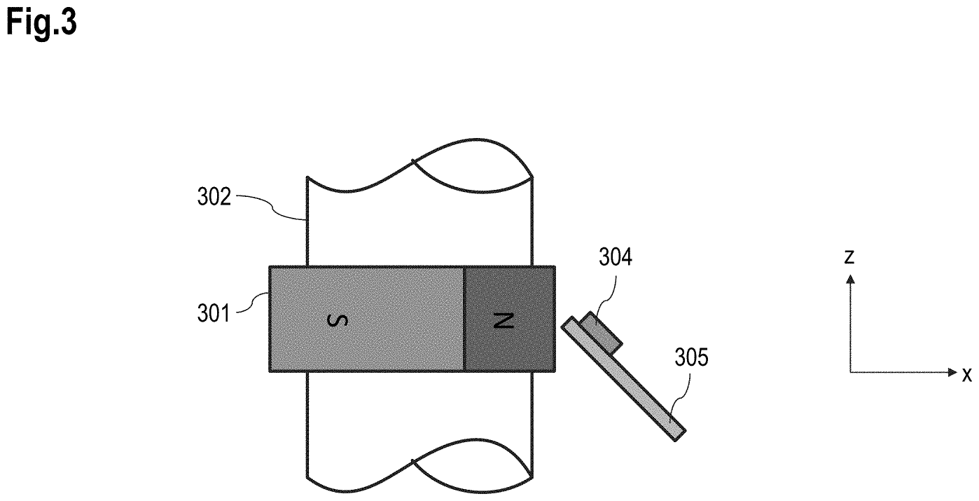

FIG. 3 shows an example arrangement comprising a ring magnet 301 that is connected to a (rotatable) shaft 302. An out-of-shaft magnetic field sensor 304 (also referred to as angle sensor) detects magnetic field components from the ring magnet 301, wherein the magnetic field sensor 304 is tilted against the x-axis thereby reducing the x-component of the detected magnetic field. The magnetic field sensor 304 is mounted on a printed circuit board (PCB) 305.

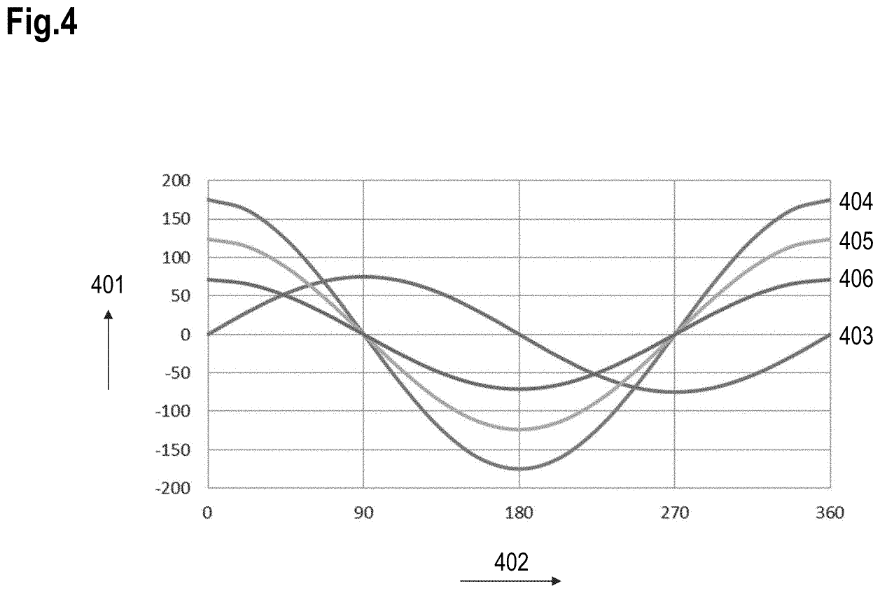

FIG. 4 shows the resulting magnetic field components by depicting a magnetic flux density 401 in view of a rotational angle 402. In FIG. 4,
a curve 403 shows a magnetic field component By in y-direction with a tilt against the x-axis amounting to 0°, 45° or 66°,
a curve 404 shows a magnetic field component Bx in x-direction with a tilt against the x-axis amounting to 0°,
a curve 405 shows a magnetic field component Bx in x-direction with a tilt against the x-axis amounting to 45°,
a curve 406 shows a magnetic field component Bx in x-direction with a tilt against the x-axis amounting to 66°.

Hence, the larger the tilt against the x-axis, the smaller becomes the amplitude of the magnetic field component Bx.

The out-of-shaft angle sensor arrangement may use a diametrically magnetized permanent magnet.

The shaft itself may or may not be ferrous. This may impact the magnitude of the relevant magnetic field components.

The angle sensor may be placed at a radial airgap with a clearance amounting to, e.g., 1 mm to 2 mm between the rotatable parts (in the example shown in FIG. 3: the shaft 302 with the ring magnet 301) and the magnetic field sensor 304. The magnetic field sensor 304 may be fixed compared to the rotatably arranged shaft 302 (with its ring magnet 301 that is fixed on the shaft 302 so that the ring magnet 301 rotates together with the shaft 302).

The shaft 302 may have axial and/or radial play, wherein the axial play may be larger than the radial play depending on the diameter of the shaft 302 and the mechanical load on the shaft 302.

The angle sensor may advantageously be placed in the mid-plane of the magnet, where the magnetic field changes least due to axial play. However, in this mid-plane the amplitude of the radial and azimuthal magnetic field components differ significantly from each other, whereas the axial field component vanishes. All non-vanishing components are sine-waves with 90° phase shifts against orthogonal components. If the end of the magnetic field vector is fixed while the magnet rotates, the tip of the magnetic field vector (or the magnetic field pointer) rotates on an ellipse where the ellipticity corresponds to a ratio of amplitudes of both orthogonal components.

If the sensor is a MR sensor, such ellipticity may be detrimental. Instead, the pointer should move on a circle. Then, the magnetic angle detected by the MR sensor is identical to the rotational angle of the magnet. In some cases, a zero-shift of 90° or 45° could be added.

In other words, an ellipticity (that is different from a circle) leads to a nonlinear distortion between the angle detected by the angle sensor and the actual rotation angle. This distortion can be compensated using a look-up table (LUT) or a linearization function. However, if the sensor and/or the magnet is/are slightly mispositioned (e.g., by axial play or mounting tolerances), the LUT being static cannot compensate such tolerances. Hence, without information about the position tolerances, the sensor system cannot efficiently compensate the varying distortions.

Tilting the angle sensor allows reducing the stronger of the magnetic field components in the x-y-plane.

In other words, the tilt reduces the portion of the radial magnetic field component, which is projected on the tilted chip surface (the major chip surface is the relevant plane onto which the MR elements are sputtered and they respond only to magnetic field components that are parallel to this plane).

Advantageously, the angle sensor is placed at z=0, which corresponds to the middle (symmetry plane) of the ring magnet. In such case, the magnetic field component Bz does not (significanity) contribute to the magnetic field detected by the angle sensor.

Other magnet shapes may be used as well, e.g., magnets with no mirror symmetry plane at z=0. Such magnets may have other locations where the magnetic field component Bz is (substantially) 0 thereby giving an indication where to place the tilted angle sensor. The solution described herein could be accordingly used in combination with these magnets.

Hence, the solutions described herein may suggest combining a ring magnet (on a rotatable shaft) with at least one magnetic field sensor as an angle sensor (each magnetic field sensor may comprise several sensor elements), wherein the magnetic field sensor responds to a projection of the magnetic field on a sensor plane (exemplarily referred to as x-y-plane). This sensor plane may correspond, e.g., to the main chip surface. The magnetic field sensor is placed at a location where the magnetic field component Bz (which is orthogonal to the x-y-plane) is substantially zero (preferably for all rotational positions of the shaft). Then, the magnetic field sensor is tilted so that the projection of the magnetic field on the magnetic field sensor reaches a reduced ellipticity and preferably (approximately) the shape of a circle (compared to the ellipticity without tilt applied to the magnetic field sensor).

In this location one edge of the chip surface (either the height or the width) is perpendicular to the rotation axis and the other one is not perpendicular to the rotation axis.

Example Implementation: Tilt-Mounted PCB

In the example shown in FIG. 3, the magnetic field sensor 304 is mounted on the PCB 305. The whole PCB 305 with all components can be arranged with a tilt angle and the magnetic field sensor 304 can be soldered in a conventional way (SMD or Leaded Package) on the PCB 305.

Example Implementation: Tilt of Leaded Package

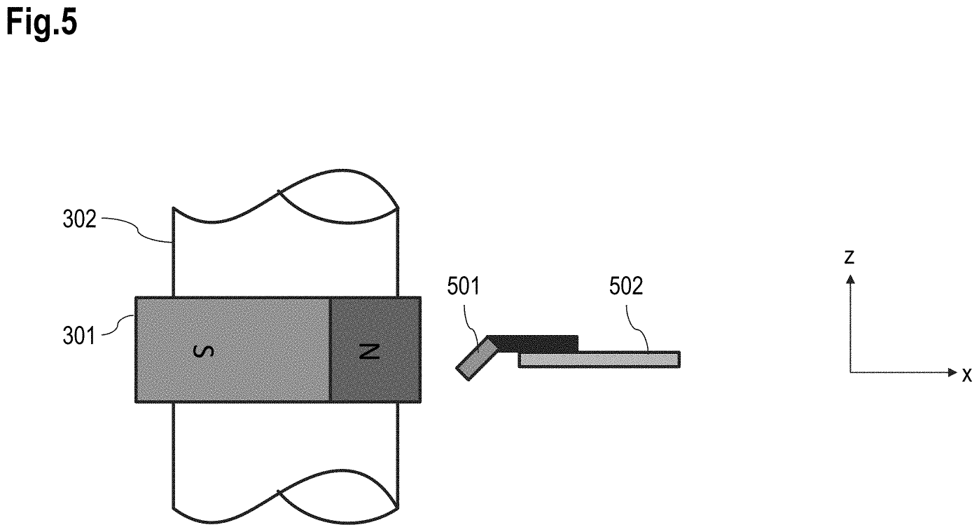

FIG. 5 shows an example arrangement comprising the ring magnet 301 that is arranged on the shaft 302. Here, an angle sensor 501 is mounted on a PCB 502, wherein the package comprising the angle sensor 501 is bent, e.g., at the end of a PCB production stage.

Example Implementation: Tilt Mount of SMD-Package

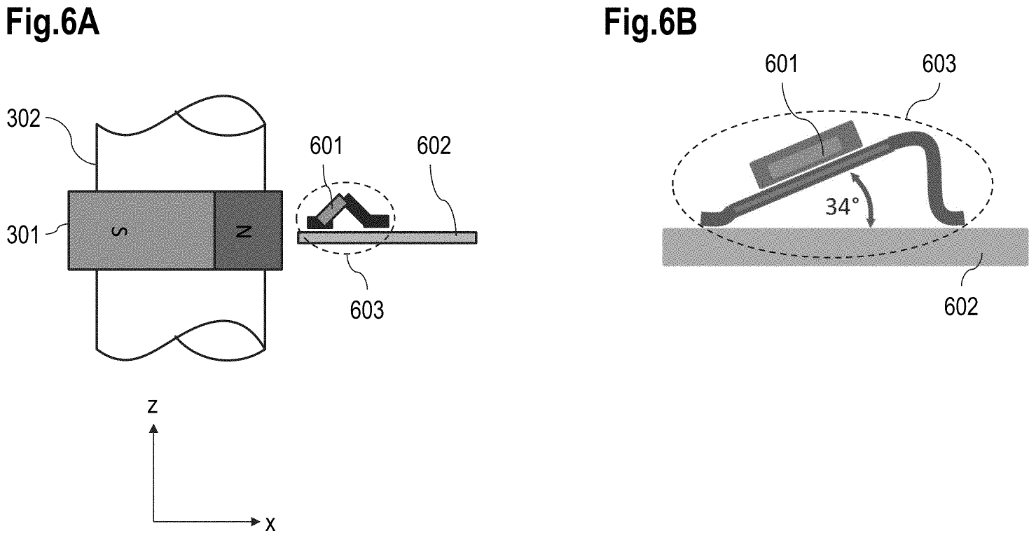

FIG. 6A shows another example arrangement comprising the ring magnet 301 that is arranged on the shaft 302. Here, an angle sensor 601 is part of a package 603 that is mounted on a PCB 602. The package 603 may be an SMD-package sensor which comprises the tilted angle sensor 601.

FIG. 6B shows the package 603 in more detail. Here, the angle sensor 601 is part of the package 603 and it is tilted against the x-axis by 34°.

Example Implementation: PCB Stack for SMD-Package

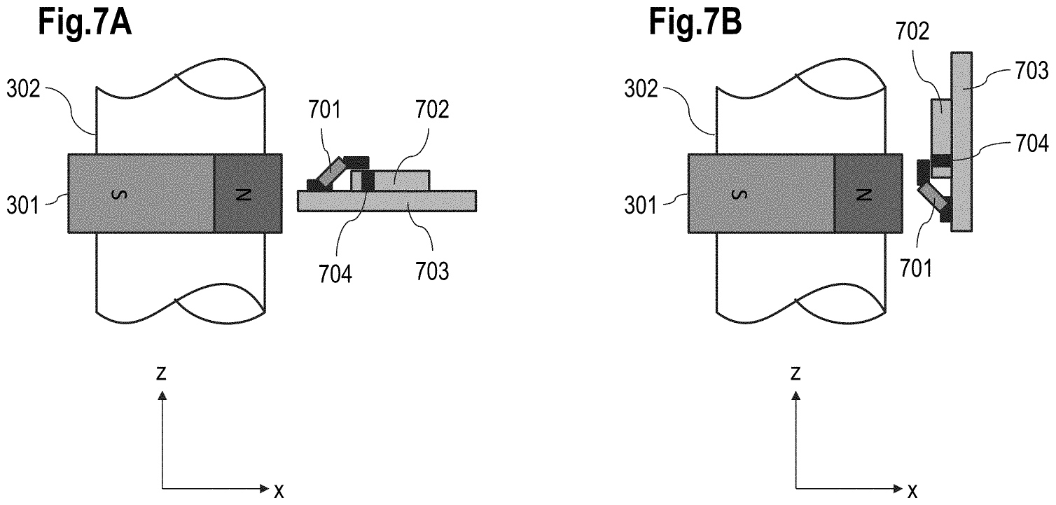

FIG. 7A shows yet another example arrangement comprising the ring magnet 301 that is arranged on the shaft 302. In this example, a stacked PCB arrangement comprising PCBs 702 and 703 are used to support an angle sensor 701. A via 704 through the PCB 702 can be used to electrically connect the angle sensor 701 with the PCB 703.

The PCB arrangement can be placed in the x-y-plane as shown in FIG. 7A or in the x-z-plane as shown in FIG. 7B. It is noted that the y-axis is orthogonal to the x-z-plane and is directed towards (or from) the image plane.

Further Implementations and Advantages

It is noted that the sensor plane can be tilted clock-wise or counter-clock-wise.

Both tilts (clock- or counter-clock-wise) lead to similar results, because they affect the projection of the magnetic field in similar ways. However, an axial play of the magnet may result in the angle sensor moving out of its mid-plane where the magnetic field component Bz equals 0. Then, both tilts affect the angle error in different ways.

In such case, it may be advantageous to provide two angle sensors with different tilts (e.g. one with a tilted angle a applied clock-wise and the other with the tilted angle a applied counter-clock-wise) and combine their outputs to reduce errors of axial play. As an example, the average values of angles from both angle sensors may be combined. For example, the sine and cosine of each angle can be taken, then sines of both sensors and cosines of both sensors can be averages. Finally, the angle associated with these two sin/cos values is computed.

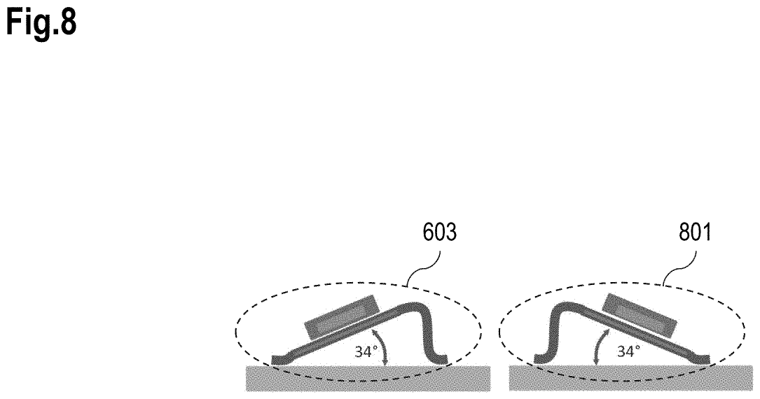

FIG. 8 shows an example arrangement of two tilted angle sensors comprising the package 603 shown in FIG. 6 and a mirrored package 801: The package 603 uses the tilted angle amounting to 34° applied clock-wise and the package 801 uses the tilted angle amounting to 34° applied counter-clock-wise.

Both tilted sensors can be mounted within a single package having die paddles with opposite tilts, or by placing two sensors packages as shown in FIG. 8. They may be placed on one PCB or on different PCBs.

The tilted sensors may be deployed side-by-side.

Both clock-wise and counter-clock-wise arranged angle sensors may also be utilized in the examples shown in FIG. 3, FIG. 5, FIG. 6A, FIG. 7A or FIG. 7B.

In an example, the two sensor chips may be placed at different angular position around the magnet, but preferably at (substantially) identical radial and axial positions. They can be placed side by side (e.g., at angular positions 0° and 20°) or at a larger spacing, e.g., on angular positions 0° and 180°, e.g. on opposite sides of the shaft. The latter version is more robust against eccentricities of the component board versus the rotation axis and on externally applied magnetic field disturbances, which may cancel out, when both sensor signals are combined.

Although various example implementations have been disclosed, it will be apparent to those skilled in the art that various changes and modifications can be made which will achieve some of the advantages of the example implementations without departing from the spirit and scope of the example implementations. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the example implementations may be achieved in either all software implementations, using the appropriate processor instructions, or in hybrid implementations that utilize a combination of hardware logic and software logic to achieve the same results. Such modifications to the example implementations are intended to be covered by the appended claims.

1. A rotation angle sensing device comprising:
a shaft that is rotatable around a rotation axis;
a magnetic field source that is attached to the shaft; and
at least one angle sensor that is arranged at an out-of-shaft location adjacent to the magnetic field source,
wherein the at least one angle sensor comprises a plane for measuring two components of a magnetic field emitted by the magnetic field source,
wherein the plane is tilted against the rotation axis of the shaft.

2. The rotation angle sensing device according to claim 1, wherein the magnetic field source is fixed on the shaft and the magnetic field source comprises at least one of:
a permanent magnet; or
a ring magnet.

3. The rotation angle sensing device according to claim 1, wherein the plane is tilted such that the two components of the magnetic field have a same amplitude or substantially a same amplitude.

4. The rotation angle sensing device according to claim 1, wherein the at least one angle sensor is part of a package, which is mounted on a printed circuit board.

5. The rotation angle sensing device according to claim 4, wherein the package is tilted and/or the at least one angle sensor within the package is tilted.

6. The rotation angle sensing device according to claim 1, wherein the at least one angle sensor is tilted by a tilt angle in a range from approximately 15° to approximately 75°.

7. The rotation angle sensing device according to claim 1, wherein the at least one angle sensor comprises two angle sensors that are tilted in opposite directions.

8. The rotation angle sensing device according to claim 1, wherein the at least one angle sensor is deployed at a location where a magnetic field component in a direction of the rotation axis is substantially zero.

9. The rotation angle sensing device according to claim 1, wherein the at least one angle sensor is placed adjacent to the magnetic field source, wherein a radial distance between the magnetic field source and the at least one angle sensor is in the range from approximately 0.5 mm to approximately 10 mm.

10. The rotation angle sensing device according to claim 1, wherein the at least one angle sensor comprises at least one of:
an anisotropic magneto-resistive (AMR) sensor;
a giant magneto-resistive (AMR) sensor; or
a tunneling magneto-resistive (GMR) sensor.

11. The rotation angle sensing device according to claim 1, wherein the at least one angle sensor comprises at least one of:
a Hall plate; or
a vertical Hall effect device.

12. A method for sensing a rotational angle of a shaft that is rotatable around a rotation axis, wherein a magnetic field source is attached to the shaft and wherein at least one angle sensor is arranged at an out-of-shaft location adjacent to the magnetic field source, wherein the at least one angle sensor comprises a plane for measuring two components of a magnetic field emitted by the magnetic field source, wherein the plane is tilted against the rotation axis of the shaft, the method comprising:
determining the two components of the magnetic field in the plane of the at least one angle sensor, and
determining the rotational angle of the shaft based on the two components of the magnetic field.

13. The method according to claim 12, wherein the magnetic field source is fixed on the shaft and the magnetic field source comprises at least one of:
a permanent magnet; or
a ring magnet.

14. The method according to claim 12, wherein the plane is tilted such that the two components of the magnetic field have a same amplitude or substantially a same amplitude.

15. The method according to claim 12, wherein the at least one angle sensor is part of a package, which is mounted on a printed circuit board.

16. The method according to claim 15, wherein the package is tilted and/or the at least one angle sensor within the package is tilted.

17. The method according to claim 12, wherein the at least one angle sensor is tilted by a tilt angle in a range from approximately 15° to approximately 75°.

18. The method according to claim 12, wherein the at least one angle sensor comprises two angle sensors that are tilted in opposite directions.

19. The method according to claim 12, wherein the at least one angle sensor is deployed at a location where a magnetic field component in a direction of the rotation axis is substantially zero.

20. The method according to claim 12, wherein the at least one angle sensor is placed adjacent to the magnetic field source, wherein a radial distance between the magnetic field source and the at least one angle sensor is in a range from approximately 0.5 mm to approximately 10 mm.
